(19) United States
(12) Patent Application Publication
(10) Pub. No.: US 2013/0310195 A1
(43) Pub. Date: Nov. 21, 2013

(54) Method Apparatus for Producing a Golf Ball

(71) Applicant: Arthur MOLINARI, Beaverton, OR (US)

(72) Inventor: Arthur MOLINARI, Beaverton, OR (US)

(73) Assignee: NIKE INC., Beaverton, OR (US)

(21) Appl. No.: 13/475,595

(22) Filed: May 18, 2012

(51) Int. Cl. B05D 3/12; B05C 13/00; A63B 37/12

(52) U.S. Cl. 473/371; 427/331; 118/56

(57) ABSTRACT

Aspects of the disclosure relate to a method of producing a golf ball, which may include creating a core of the golf ball, creating an outer cover of the golf ball around the core of the golf ball and applying a coating material to the golf ball. Further, creating the outer cover of the golf ball around the core of the golf ball, may include creating one or more gates, or flash, attached to the outer cover of the golf ball, wherein the one or more gates, or at least a portion of the flash, remain attached to the outer cover of the golf ball while the coating material is applied to the golf ball.

### BACKGROUND

Generally, golf balls may comprise either a one-piece construction or several layers including an outer cover surrounding a core. Further, typically, one or more layers of coating (e.g., paint and/or clear coat) may be applied to the outer surface of the golf ball. The coating may serve a variety of functions, such as protecting the cover material, improving aerodynamics of ball flight, preventing yellowing, and/or improving aesthetics of the ball.

However, conventional methods and systems for constructing golf balls may prevent the dimensional stability of the golf ball and, further, the uniformity of the properties of the golf ball from being optimized. For example, conventional methods and systems for constructing the outer cover of the golf ball may prevent the dimensional stability of the golf ball and, further, the uniformity of the properties of the golf ball from being optimized It would be advantageous to have a system and method of producing a golf ball which increases the dimensional stability of the golf ball and, further, increases the uniformity of the properties of the golf ball.

### SUMMARY

The following presents a general summary of aspects of the invention in order to provide a basic understanding of the invention and various features of it. This summary is not intended to limit the scope of the invention in any way, but it simply provides a general overview and context for the more detailed description that follows.

Aspects of the disclosure relate to a method of producing a golf ball, which may include creating a core of the golf ball, creating an outer cover of the golf ball around the core of the golf ball and applying a liquid to the golf ball. Further, creating the outer cover of the golf ball around the core of the golf ball, may include creating one or more gates, or flash, attached to the outer cover of the golf ball, wherein the one or more gates, or at least a portion of the flash, remain attached to the outer cover of the golf ball while the liquid is applied to the golf ball.

Aspects of the disclosure relate to a method of producing a golf ball, which may include creating a core of the golf ball, creating an outer cover of the golf ball around the core of the golf ball, and applying a coating material to the golf ball. Further, creating the outer cover of the golf ball around the core of the golf ball may include creating a runner system attached to the outer cover of the golf ball, wherein at least a portion of the runner system remains attached to the outer cover of the golf ball while the coating material is applied to the golf ball.

Aspects of the disclosure relate to a system for producing a golf ball which may include an apparatus for creating a core of the golf ball and an apparatus for creating an outer cover of the golf ball around the core of the golf ball, wherein the apparatus for creating the outer cover of the golf ball also produces flash on the outer cover of the golf ball and, also, a runner system including one or more gates. Further, the system may include an apparatus for applying a coating material to the outer cover of the golf ball and an apparatus for transporting the golf ball through at least a portion of the system by holding or manipulating at least a portion of the runner system.

### BRIEF DESCRIPTION OF THE DRAWINGS

A more complete understanding of the present invention and certain advantages thereof may be acquired by referring to the following detailed description in consideration with the accompanying drawings, in which:

FIGS. 1 and 1A schematically illustrate a cross-sectional view of a golf ball according to aspects of the disclosure.

FIG. 2 schematically illustrates a side view an example of a mold for producing golf balls according to one aspect of the disclosure;

FIG. 2A illustrates a side view of the mold for producing golf balls shown in FIG. 2 in an open position;

FIG. 2B illustrates a top view of the lower half of the mold for producing golf balls which is shown in FIG. 2;

FIG. 3 illustrates an example runner system according to one aspect of the disclosure;

FIGS. 4 and 4A illustrate a golf ball wherein gates and flash are attached to the golf ball according to aspects of the disclosure;

FIG. 5 illustrates a plurality of golf balls attached to a runner system wherein the runner system is used to move the plurality of golf balls through a step in the manufacturing process according to aspects of the disclosure;

FIG. 6 illustrates a plurality of golf balls attached to a runner system wherein the runner system is used to move the plurality of golf balls through a step in the manufacturing process according to aspects of the disclosure; and

FIG. 7 illustrates a plurality of golf ball cores attached to a runner system wherein the runner system is used to move the plurality of golf balls through a step in the manufacturing process according to aspects of the disclosure.

### DETAILED DESCRIPTION

In the following description of various example structures, reference is made to the accompanying drawings, which form a part hereof, and in which are shown by way of illustration various example golf ball structures. Additionally, it is to be understood that other specific arrangements of parts and structures may be utilized and structural and functional modifications may be made without departing from the scope of the present invention. Also, while terms such as “top,” “bottom,” “front,” “back,” “rear,” “side,” “underside,” “overhead,” and the like may be used in this specification to describe various example features and elements of the invention, these terms are used herein as a matter of convenience, e.g., based on the example orientations shown in the figures and/or the orientations in typical use. Nothing in this specification should be construed as requiring a specific three dimensional or spatial orientation of structures.

Golf balls may be of varied construction, e.g., one-piece balls, two-piece balls, three-piece balls (including wound balls), four-piece balls, etc. The difference in play characteristics resulting from these different types of constructions can be quite significant. Generally, golf balls may be classified as solid or wound balls. Solid balls that have a two-piece construction, typically a cross-linked rubber core, e.g., polybutadiene cross-linked with zinc diacrylate and/or similar cross-linking agents, encased by a blended cover, e.g., ionomer resins, are popular with many average recreational golfers. The combination of the core and cover materials provide a relatively “hard” ball that is virtually indestructible by golfers and one that imparts a high initial velocity to the ball, resulting in improved distance. Because the materials of which the ball is formed are very rigid, two-piece balls tend to have a hard “feel” when struck with a club. Likewise, due to their hardness, these balls have a relatively low spin rate, which also helps provide greater distance.

Wound balls are generally constructed from a liquid or solid center surrounded by tensioned elastomeric material and covered with a durable cover material, e.g., ionomer resin, or a softer cover material, e.g., balata or polyurethane. Wound balls are generally thought of as performance golf balls and have good resiliency, desirable spin characteristics, and feel when struck by a golf club. However, wound balls are generally difficult to manufacture as compared to solid golf balls.

More recently, three- and four-piece balls have gained popularity, both as balls for average recreational golfers as well as performance balls for professional and other elite level players.

A variety of golf balls have been designed to provide particular playing characteristics. These characteristics generally include the initial velocity and spin of the golf ball, which can be optimized for various types of players. For instance, certain players prefer a ball that has a high spin rate in order to control and stop the golf ball around the greens. Other players prefer a ball that has a low spin rate and high resiliency to maximize distance. Generally, a golf ball having a hard core and a soft cover will have a high spin rate. Conversely, a golf ball having a hard cover and a soft core will have a low spin rate. Golf balls having a hard core and a hard cover generally have very high resiliency for distance, but are hard feeling and difficult to control around the greens.

The carry distance of some conventional two-piece balls has been improved by altering the typical single layer core and single cover layer construction to provide a multi-layer ball, e.g., a dual cover layer, dual core layer, and/or a ball having an intermediate layer disposed between the cover and the core. Three- and four-piece balls are now commonly found and commercially available. Aspects of this invention may be applied to all types of constructions, including the various wound, solid, and/or multi-layer ball constructions described above.

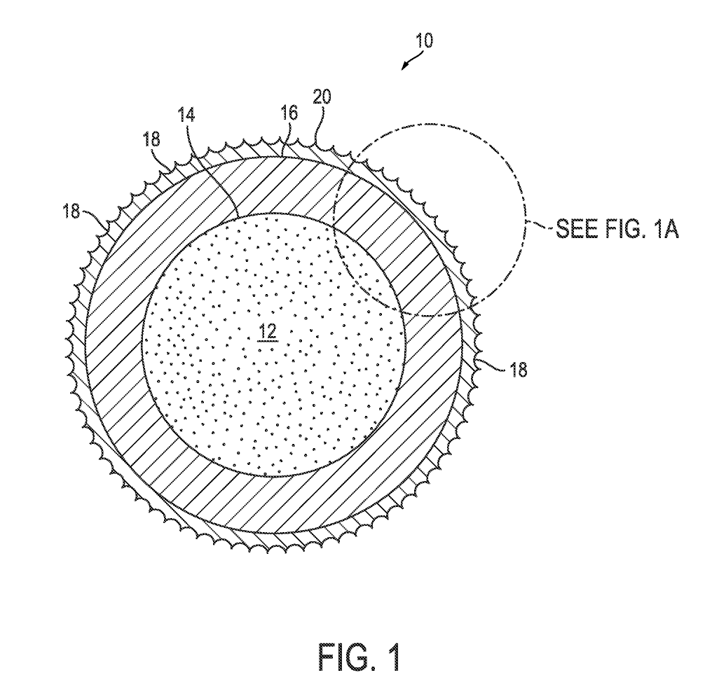

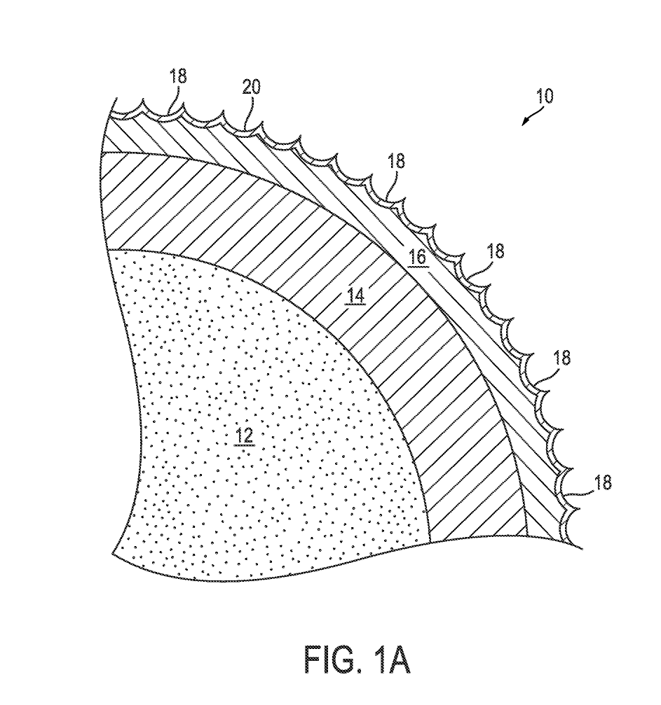

FIGS. 1 and 1A show an example of a golf ball 10, which has a core 12, an intermediate layer 14, an outer cover 16 having a plurality of dimples 18, and a topcoat 20 applied over the exterior surface of the golf ball 10. The golf ball 10 alternatively may be only one piece such that the core 12 represents the entirety of the golf ball 10, and the plurality of dimples are formed on the core 12. The ball 10 also may have any other construction, including the various example constructions described herein. The thickness of the topcoat 20 typically is significantly less than that of the cover 16 or the intermediate layer 14, and by way of example may range from about 5 to about 25 μm. The topcoat 20 should have a minimal effect on the depth and volume of the dimples 18. Each of the above described portions of the golf ball will be described in further detail below.

A golf ball may be formed, for example, with a center having a low compression, but still exhibit a finished ball COR and initial velocity approaching that of conventional two-piece distance balls. The center may have, for example, a compression of about 60 or less. The finished balls made with such centers have a COR, measured at an inbound speed of 125 ft./s., of about 0.795 to about 0.815. “COR” refers to Coefficient of Restitution, which is obtained by dividing a ball's rebound velocity by its initial (i.e., incoming) velocity. This test is performed by firing the samples out of an air cannon at a vertical steel plate over a range of test velocities (e.g., from 75 to 150 ft/s). A golf ball having a high COR dissipates a smaller fraction of its total energy when colliding with the plate and rebounding therefrom than does a ball with a lower COR.

The terms “points” and “compression points” refer to the compression scale or the compression scale based on the ATTI Engineering Compression Tester. This scale, which is well known to persons skilled in the art, is used in determining the relative compression of a center or ball.

The center may have, for example, a Shore C hardness of about 65 to about 80. The center may have a diameter of about 1.25 inches to about 1.5 inches. The base composition for forming the center may include, for example, polybutadiene and about 20 to 50 parts of a metal salt diacrylate, dimethacrylate, or monomethacrylate. If desired, the polybutadiene can also be mixed with other elastomers known in the art, such as natural rubber, styrene butadiene, and/or isoprene, in order to further modify the properties of the center. When a mixture of elastomers is used, the amounts of other constituents in the center composition are usually based on 100 parts by weight of the total elastomer mixture.

Metal salt diacrylates, dimethacrylates, and monomethacrylates include without limitation those wherein the metal is magnesium, calcium, zinc, aluminum, sodium, lithium or nickel. Zinc diacrylate, for example, provides golf balls with a high initial velocity in the United States Golf Association (“USGA”) test.

Free radical initiators often are used to promote cross-linking of the metal salt diacrylate, dimethacrylate, or monomethacrylate and the polybutadiene. Suitable free radical initiators include, but are not limited to peroxide compounds, such as dicumyl peroxide; 1,1-di(t-butylperoxy) 3,3,5-trimethyl cyclohexane; bis(t-butylperoxy)diisopropylbenzene; 2,5-dimethyl-2,5 di(t-butylperoxy)hexane; or di-t-butyl peroxide; and mixtures thereof. The initiator(s) at 100 percent activity may be added in an amount ranging from about 0.05 to about 2.5 pph based upon 100 parts of butadiene, or butadiene mixed with one or more other elastomers. Often the amount of initiator added ranges from about 0.15 to about 2 pph, and more often from about 0.25 to about 1.5 pph. The golf ball centers may incorporate 5 to 50 pph of zinc oxide (ZnO) in a zinc diacrylate-peroxide cure system that cross-links polybutadiene during the core molding process.

The center compositions may also include fillers, added to the elastomeric composition to adjust the density and/or specific gravity of the center. Non-limiting examples of fillers include zinc oxide, barium sulfate, and regrind, e.g., recycled core molding matrix ground to about 30 mesh particle size. The amount and type of filler utilized is governed by the amount and weight of other ingredients in the composition, bearing in mind a maximum golf ball weight of 1.620 oz has been established by the USGA. Fillers usually range in specific gravity from about 2.0 to about 5.6. The amount of filler in the center may be lower such that the specific gravity of the center is decreased.

The specific gravity of the center may range, for example, from about 0.9 to about 1.3, depending upon such factors as the size of the center, cover, intermediate layer and finished ball, as well as the specific gravity of the cover and intermediate layer.

Other components such as accelerators, e.g., tetra methylthiuram, processing aids, processing oils, plasticizers, dyes and pigments, antioxidants, as well as other additives well known to the skilled artisan may also be used in amounts sufficient to achieve the purpose for which they are typically used.

The golf ball also may have one or more intermediate layers formed, for example, from dynamically vulcanized thermoplastic elastomers, functionalized styrene-butadiene elastomers, thermoplastic rubbers, thermoset elastomers, thermoplastic urethanes, metallocene polymers, thermoset urethanes, ionomer resins, or blends thereof. For example, an intermediate layer may include a thermoplastic or thermoset polyurethane. Non-limiting of commercially available dynamically vulcanized thermoplastic elastomers include SANTOPREN®, SARLINK®, VYRAM®, DYTRON®, and VISTAFLEX®. SANTOPRENE® is a dynamically vulcanized PP/EPDM. Examples of functionalized styrene-butadiene elastomers, i.e., styrene-butadiene elastomers with functional groups such as maleic anhydride or sulfonic acid, include KRATON FG-1901x and FG-1921x, which are available from the Shell Corporation of Houston, Tex.

Examples of suitable thermoplastic polyurethanes include ESTANE® 58133, ESTANE® 58134 and ESTANE® 58144, which are commercially available from the B. F. Goodrich Company of Cleveland, Ohio.

Examples of metallocene polymers, i.e., polymers formed with a metallocene catalyst, include those commercially available from Sentinel Products of Hyannis, Mass. Suitable thermoplastic polyesters include polybutylene terephthalate. Thermoplastic ionomer resins may be obtained by providing a cross metallic bond to polymers of monoolefin with at least one member selected from the group consisting of unsaturated mono- or di-carboxylic acids having 3 to 12 carbon atoms and esters thereof (the polymer contains 1 to 50 percent by weight of the unsaturated mono- or di-carboxylic acid and/or ester thereof). More particularly, low modulus ionomers such as acid-containing ethylene copolymer ionomers, include E/X/Y copolymers where E is ethylene, X is a softening comonomer such as acrylate or methacrylate. Non-limiting examples of ionomer resins include SURLYN® and LOTEK®, which are commercially available from DuPont and Exxon, respectively.

Alternatively, the intermediate layer may be a blend of a first and a second component wherein the first component is a dynamically vulcanized thermoplastic elastomer, a functionalized styrene-butadiene elastomer, a thermoplastic or thermoset polyurethane or a metallocene polymer and the second component is a material such as a thermoplastic or thermoset polyurethane, a thermoplastic polyetherester or polyetheramide, a thermoplastic ionomer resin, a thermoplastic polyester, another dynamically vulcanized elastomer, another a functionalized styrene-butadiene elastomer, another a metallocene polymer or blends thereof. At least one of the first and second components may include a thermoplastic or thermoset polyurethane.

An intermediate layer also may be formed from a blend containing an ethylene methacrylic/acrylic acid copolymer. Non-limiting examples of acid-containing ethylene copolymers include ethylene/acrylic acid; ethylene/methacrylic acid; ethylene/acrylic acid/n- or isobutyl acrylate; ethylene/methacrylic acid/n- or iso-butyl acrylate; ethylene/acrylic acid/methyl acrylate; ethylene/methacrylic acid/methyl acrylate; ethylene/acrylic acid/iso-bornyl acrylate or methacrylate and ethylene/methacrylic acid/isobornyl acrylate or methacrylate. Examples of commercially available ethylene methacrylic/acrylic acid copolymers include NUCREL® polymers, available from DuPont.

Alternatively, an intermediate layer may be formed from a blend which includes an ethylene methacrylic/acrylic acid copolymer and a second component which includes a thermoplastic material. Suitable thermoplastic materials for use in the intermediate blend include, but are not limited to, polyesterester block copolymers, polyetherester block copolymers, polyetheramide block copolymers, ionomer resins, dynamically vulcanized thermoplastic elastomers, styrene-butadiene elastomers with functional groups such as maleic anhydride or sulfonic acid attached, thermoplastic polyurethanes, thermoplastic polyesters, metallocene polymers, and/or blends thereof.

The intermediate layer often has a specific gravity of about 0.8 or more. In some examples the intermediate layer has a specific gravity greater than 1.0, e.g., ranging from about 1.2 to about 1.3. Specific gravity of the intermediate layer may be adjusted, for example, by adding a filler such as barium sulfate, zinc oxide, titanium dioxide and combinations thereof.

The intermediate layer blend may have a flexural modulus of less than about 10,000 psi, often from about 5,000 to about 8,000 psi. The intermediate layers often have a Shore D hardness of about 35 to 50. The intermediate layer and core construction together may have a compression of less than about 65, often from about 50 to about 65. Usually, the intermediate layer has a thickness from about 0.020 inches to about 0.125 inches.

The golf balls may include a single intermediate layer or a plurality of intermediate layers. In the case where a ball includes a plurality of intermediate layers, a first intermediate layer may include, for example, a thermoplastic material having a hardness greater than that of the core. A second intermediate layer may be disposed around the first intermediate layer and may have a greater hardness than that of the first intermediate layer. The second intermediate layer may be formed of materials such as polyether or polyester thermoplastic urethanes, thermoset urethanes, and ionomers such as acid-containing ethylene copolymer ionomers.

In addition, a third intermediate layer may be disposed in between the first and second intermediate layers. The third intermediate layer may be formed of the variety of materials as discussed above. For example, the third intermediate layer may have a hardness greater than that of the first intermediate layer.

A golf ball also typically has a cover layer that includes one or more layers of a thermoplastic or thermosetting material. A variety of materials may be used such as, ionomeric (e.g., ionomer resins), thermoplastic, elastomeric, urethane (e.g., polyurethanes), balata (natural or synthetic), polybutadiene, or combinations thereof. Further, an optional primer or basecoat may be applied to the exterior surface of the cover of the golf ball prior to application of the top coat.

It is noted that the cover may be formed of a composition including very low modulus ionomers (VLMIs). As used herein, the term “very low modulus ionomers,” or the acronym “VLMIs,” are those ionomer resins further including a softening comonomer X, commonly a (meth)acrylate ester, present from about 10 weight percent to about 50 weight percent in the polymer. VLMIs are copolymers of an α-olefin, such as ethylene, a softening agent, such as n-butyl-acrylate or iso-butyl-acrylate, and an α, β-unsaturated carboxylic acid, such as acrylic or methacrylic acid, where at least part of the acid groups are neutralized by a magnesium cation. Other examples of softening comonomers include n-butyl methacrylate, methyl acrylate, and methyl methacrylate. Generally, a VLMI has a flexural modulus from about 2,000 psi to about 10,000 psi. VLMIs are sometimes referred to as “soft” ionomers.

Ionomers, such as acid-containing ethylene copolymer ionomers, include E/X/Y copolymers where E is ethylene, X is a softening comonomer such as acrylate or methacrylate present in 0 to 50 weight percent of the polymer, and Y is acrylic or methacrylic acid present in 5 to 35 (often 10 to 20) weight percent of the polymer, wherein the acid moiety is neutralized 1 to 90 percent (usually at least 40 percent) to form an ionomer by a cation such as lithium, sodium, potassium, magnesium, calcium, barium, lead, tin, zinc or aluminum, or a combination of such cations, lithium, sodium and zinc being the most preferred. Specific acid-containing ethylene copolymers include ethylene/acrylic acid, ethylene/methacrylic acid, ethylene/acrylic acid/n-butyl acrylate, ethylene/methacrylic acid/n-butyl acrylate, ethylene/methacrylic acid/iso-butyl acrylate, ethylene/acrylic acid/iso-butyl acrylate, ethylene/methacrylic acid/n-butyl methacrylate, ethylene/acrylic acid/methyl methacrylate, ethylene/acrylic acid/methyl acrylate, ethylene/methacrylic acid/methyl acrylate, ethylene/methacrylic acid/methyl methacrylate, and ethylene/acrylic acid/n-butyl methacrylate.

To aid in the processing of the cover stock, ionomer resins may be blended in order to obtain a cover having desired characteristics. For this reason, the cover may be formed from a blend of two or more ionomer resins. The blend may include, for example, a very soft material and a harder material. Ionomer resins with different melt flow indexes are often employed to obtain the desired characteristics of the cover stock. SURLYN® 8118, 7930 and 7940 have melt flow indices of about 1.4, 1.8, and 2.6 g/10 min., respectively. SURLYN® 8269 and SURLYN® 8265 each have a melt flow index of about 0.9 g/10 min. A blend of ionomer resins may be used to form a cover having a melt flow index, for example, of from about 1 to about 3 g/10 min. The cover layer may have a Shore D hardness, for example, ranging from about 60 to about 70.

The cover generally includes thermoplastic and/or thermoset materials. For example, the cover may include a thermoplastic material such as urethane or polyurethane. Polyurethane is a product of a reaction between a polyurethane prepolymer and a curing agent. The polyurethane prepolymer is a product formed by a reaction between a polyol and a diisocyanate. Often, a catalyst is employed to promote the reaction between the curing agent and the polyurethane prepolymer. In the case of cast polyurethanes, the curing agent is typically either a diamine or glycol.

As another example, a thermoset cast polyurethane may be used. Thermoset cast polyurethanes are generally prepared using a diisocyanate, such as 2,4-toluene diisocyanate (TDI), methylenebis-(4-cyclohexyl isocyanate) (HMDI), or para-phenylene diisocyanate (“PPDI”) and a polyol which is cured with a polyamine, such as methylenedianiline (MDA), or a trifunctional glycol, such as trimethylol propane, or tetrafunctional glycol, such as N,N,N′,N′-tetrakis(2-hydroxpropyl)ethylenediamine. Other suitable thermoset materials include, but are not limited to, thermoset urethane ionomers and thermoset urethane epoxies. Other examples of thermoset materials include polybutadiene, natural rubber, polyisoprene, styrene-butadiene, and styrene-propylene-diene rubber.

When the cover includes more than one layer, e.g., an inner cover layer and an outer cover layer, various constructions and materials are suitable. For example, an inner cover layer may surround the intermediate layer with an outer cover layer disposed thereon or an inner cover layer may surround a plurality of intermediate layers. When using an inner and outer cover layer construction, the outer cover layer material may be a thermoset material that includes at least one of a castable reactive liquid material and reaction products thereof, as described above, and may have a hardness from about 30 Shore D to about 60 Shore D.

The inner cover layer may be formed from a wide variety of hard (e.g., about 65 Shore D or greater), high flexural modulus resilient materials, which are compatible with the other materials used in the adjacent layers of the golf ball. The inner cover layer material may have a flexural modulus of about 65,000 psi or greater. Suitable inner cover layer materials include the hard, high flexural modulus ionomer resins and blends thereof, which may be obtained by providing a cross metallic bond to polymers of monoolefin with at least one member selected from the group consisting of unsaturated mono- or di-carboxylic acids having 3 to 12 carbon atoms and esters thereof (the polymer contains 1 to 50 percent by weight of the unsaturated mono- or di-carboxylic acid and/or ester thereof). More particularly, such acid-containing ethylene copolymer ionomer component includes E/X/Y copolymers where E is ethylene, X is a softening comonomer such as acrylate or methacrylate present in 0-50 weight percent of the polymer, and Y is acrylic or methacrylic acid present in 5-35 weight percent of the polymer, wherein the acid moiety is neutralized about 1-90 percent to form an ionomer by a cation such as lithium, sodium, potassium, magnesium, calcium, barium, lead, tin, zinc, or aluminum, or a combination of such cations. Specific examples of acid-containing ethylene copolymers include ethylene/acrylic acid, ethylene/methacrylic acid, ethylene/acrylic acid/n-butyl acrylate, ethylene/methacrylic acid/n-butyl acrylate, ethylene/methacrylic acid/iso-butyl acrylate, ethylene/acrylic acid/iso-butyl acrylate, ethylene/methacrylic acid/n-butyl methacrylate, ethylene/acrylic acid/methyl methacrylate, ethylene/acrylic acid/methyl acrylate, ethylene/methacrylic acid/methyl acrylate, ethylene/methacrylic acid/methyl methacrylate, and ethylene/acrylic acid/n-butyl methacrylate.

Examples of other suitable inner cover materials include thermoplastic or thermoset polyurethanes, polyetheresters, polyetheramides, or polyesters, dynamically vulcanized elastomers, functionalized styrene-butadiene elastomers, metallocene polymers, polyamides such as nylons, acrylonitrile butadiene-styrene copolymers (ABS), or blends thereof.

A variety of materials may be used to form the topcoat, non-limiting examples of which include thermoplastics, thermoplastic elastomers such as polyurethanes, polyesters, acrylics, low acid thermoplastic ionomers, e.g., containing up to about 15% acid, and UV curable systems. The thickness of the topcoat typically ranges from of about 5 to about 25 μm, in some examples, from about 10 to about 15 μm.

Additional additives optionally may be incorporated into the top coat, such as flow additives, mar/slip additives, adhesion promoters, thickeners, gloss reducers, flexibilizers, cross-linking additives, isocyanates or other agents for toughening or creating scratch resistance, optical brighteners, UV absorbers, and the like. The amount of such additives may ranges from 0 to about 5 wt %, often from 0 to about 1.5 wt %.

While the different portions of an illustrative golf ball according to aspects of the disclosure (and the materials used to form the different portions of the illustrative golf ball) are described above, various methods for manufacturing the illustrative golf ball (including the different portions thereof) are described below. For example, one common technique for manufacturing golf balls is a laminate process. In order to form multiple layers around the center, a laminate is first formed. The laminate includes at least two layers and sometimes includes three layers. The laminate may be formed by mixing uncured core material to be used for each layer and calendar rolling the material into thin sheets. Alternatively, the laminate may be formed by mixing uncured intermediate layer material and rolling the material into sheets. The laminate sheets may be stacked together to form a laminate having three layers, using calender rolling mills. Alternatively, the sheets may be formed by extrusion.

A laminate also may be formed using an adhesive between each layer of material. For example, an epoxy resin may be used as adhesive. The adhesive should have good shear and tensile strength, for example, a tensile strength over about 1500 psi. The adhesive often has a Shore D hardness of less than about 60 when cured. The adhesive layer applied to the sheets should be very thin, e.g., less than about 0.004 inches thick.

Preferably, each laminate sheet is formed to a thickness that is slightly larger than the thickness of the layers in the finished golf ball. Each of these thicknesses can be varied, but all have a thickness of preferably less than about 0.1 inches. The sheets should have very uniform thicknesses.

The next step in the method is to form multiple layers around the center. This may be accomplished by placing two laminates between a top mold and a bottom mold. The laminates may be formed to the cavities in the mold halves. The laminates then may be cut into patterns that, when joined, form a laminated layer around the center. For example, the laminates may be cut into FIG. 8-shaped or barbell-like patterns, similar to a baseball or a tennis ball cover. Other patterns may be used, such as curved triangles, hemispherical cups, ovals, or other patterns that may be joined together to form a laminated layer around the center. The patterns may then be placed between molds and formed to the cavities in the mold halves. A vacuum source often is used to form the laminates to the mold cavities so that uniformity in layer thickness is maintained.

After the laminates have been formed to the cavities, the centers are then inserted between the laminates. The laminates are then compression molded about the center under conditions of temperature and pressure that are well known in the art. The mold halves usually have vents to allow flowing of excess layer material from the laminates during the compression molding process. As an alternative to compression molding, the core and/or intermediate layer(s) may be formed by injection molding or other suitable technique.

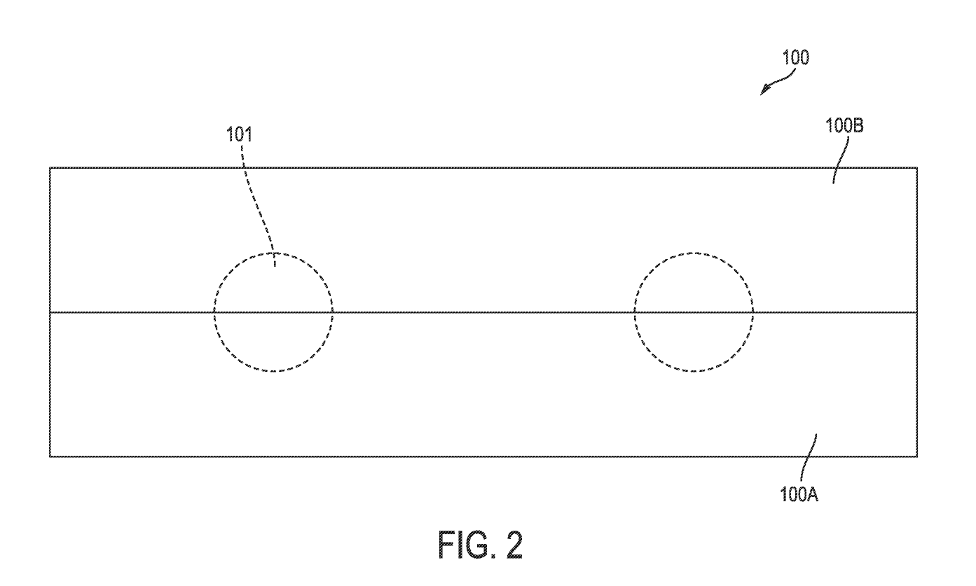

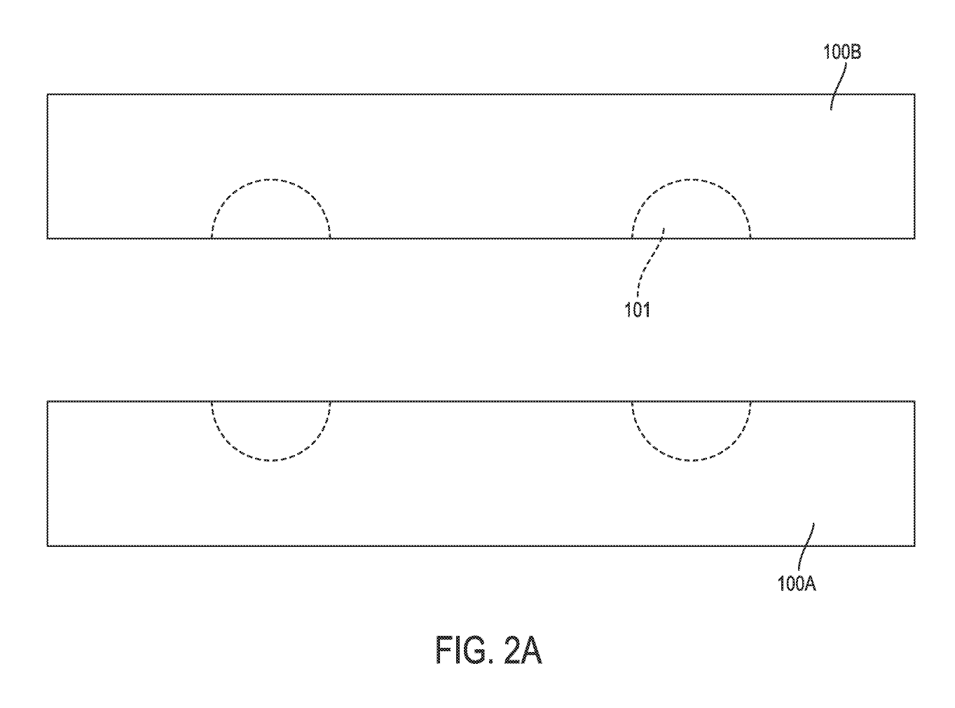

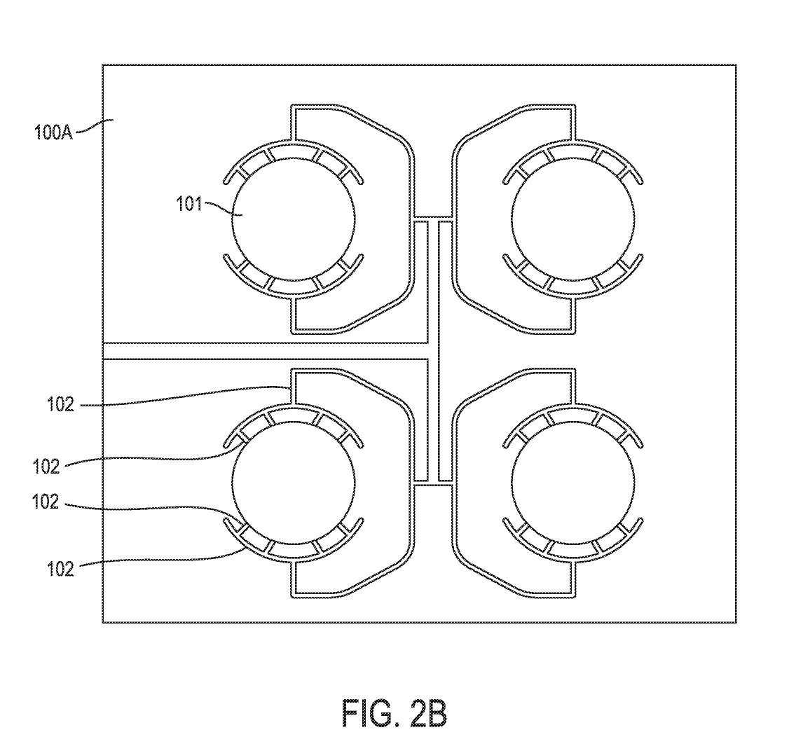

The next step involves forming a cover around the golf ball core. The core, including center and intermediate layers, may be placed in a pair of cover mold-halves. FIG. 2 illustrates an example mold 100 into which the golf ball core may be placed. As seen in FIG. 2, the mold 100 may hold a plurality of golf balls 10. For example, according to aspects of the disclosure, the mold 100 may hold four or more golf balls 10, each of which may be placed into a cavity 101 for receiving the golf ball cores 12 (and, if applicable, combined with intermediate layers 14). Further, as seen in FIG. 2, the mold 100 may include a lower mold half 100A and an upper mold half 100B. FIG. 2A is a side view of mold 100 in an open position wherein the upper and lower mold halves 100A, 100B are separated to allow access to the cavities 101. Therefore, according to aspects of the disclosure, one or more of the golf ball cores 12 (and, if applicable, combined with intermediate layers 14) may be placed into the cavities 101 and the outer cover 16 may be formed around the golf ball cores 12 (and, if applicable, combined with intermediate layers 14) as will be discussed in detail below. It is noted that according to aspects of the disclosure, the cavities 101 may be dimpled cavities so as to produce the dimples 18 in the outer cover 16 of the golf ball 10.

FIG. 2B is a top view of an illustrative lower mold half 100A according to aspects of the disclosure into which one or more of the golf ball cores 12 (and, if applicable, combined with intermediate layers 14) may be placed. It is noted that the upper mold half 100B may have a corresponding configuration. As seen in FIG. 2B, the mold halves 100A and 100B may include a plurality of cavities 101 for holding the cores 12 of the golf balls. For example, in the depicted embodiment, the mold half 100A includes four cavities 101. As seen in FIG. 2B, the mold halves 100A and 100B may include a plurality of injection ports or gates, such as edge gates or sub-gates 102 through which the material which will comprise the outer cover (e.g., the cover material) may be injected into the cavities 101 of the mold 100. As seen in FIG. 2B, the edge gates or sub gates 102 may comprise arc shaped and linear channels. Further, as seen in FIG. 2B, a plurality of channels which actually directly connect to the cavity 101 may be positioned so as to surround the cavity 101. For example, in the depicted embodiment, the edge gates or sub gates 102 may include eight channels which connect directly with the cavity 101 and are positioned around the cavity 101 in pairs relatively equidistantly around the cavity. In this way, the cover material may be evenly distributed into the cavity 101 and, further, upon solidification of the cover material in the channels which directly connect with the cavity 101, the golf ball 10 may be evenly supported. Of course, other configurations of the arc shaped and linear channels which comprise the edge gates or sub gates 102 may be used and, in fact, other shaped channels may be used if desired.

It is noted that the cores 12 may be supported in the cavities 101 by a plurality of retractable pins (not shown). The retractable pins may be actuated by conventional means known to those of ordinary skill in the art. After the mold halves 100A and B are closed together with the pins supporting the cores 12, the cover material is injected into the mold 100 in a liquid state through the plurality of injection ports or gates, such as edge gates or sub-gates 102. The retractable pins may be retracted after a predetermined amount of cover material has been injected into the cavities 101 of the mold halves 100 A and B to substantially surround the core. The liquid cover material is allowed to flow and substantially fill the cavity 101 between the core 12 and the mold halves 100 A and B, while maintaining concentricity between the core 12 and the mold halves 100 A and B. The cover material is then allowed to solidify around the core 12, and the golf balls are removed from the mold halves 100 A and B and may be subjected to finishing processes, including topcoating, painting, and/or other finishing processes, including processes in accordance with examples of this invention, as will be described in more detail below.

According to aspects of the disclosure, the finishing processes may include applying a liquid to the golf ball. Further, according to aspects of the disclosure, the finishing processes may include applying a coating material (e.g., a liquid coating material) to the golf ball. For example, according to aspects of the disclosure, golf balls may be dipped in a coating material. According to aspects of the disclosure, the coating material may include the primer, the base coat or the top coat described above or other materials applied to the surface of the golf ball (e.g., the surface of the outer cover 16). Also, it is noted that the coating material may include some or all of the above described materials that make up the primer, the base coat or the top coat.

It is noted that the term coating material does not imply that the material must coat the entire surface of the golf ball. Instead, it may be applied only to a particular surface of the golf ball. Further, the term coating material does not imply that the material must necessarily remain on the surface of the golf ball to which it is applied. Instead, according to aspects of the disclosure, the coating material may be partially or fully absorbed into the surface of the golf ball to which it is applied (e.g., the surface of the outer cover 16 of the golf ball) or may partially or fully coat the golf ball 10 without being partially absorbed or fully absorbed into the surface of the golf ball.

Further, it is noted that while the above described embodiments discuss applying a coating material in a finishing process, aspects of the disclosure include applying a liquid to the surface of the golf ball prior to a finishing process. For example, aspects of the disclosure include applying a coating material to the surface of the golf ball prior to a finishing process. Further, in some other instances the surface of the golf ball to which the liquid is applied may be the surface of the outer cover 16 (e.g., prior to, during or after finishing process), the surface of the core 12 of the golf ball or the surface of the intermediate layer 14 of the golf ball as will be described in further detail below.

A coating material may include a variety of materials, such as isocyanates and the like. According to particular embodiments of the disclosure, the coating material may include adhesive.

As discussed above, in some embodiments, coating a surface of the golf ball 10 includes applying a liquid to the surface of the golf ball 10. For example, according to aspects of the disclosure, the golf balls may be submerged into a tank or other container of the coating material. In some embodiments of the disclosure, the coating material may be used in order to coat the golf ball and/or provide the golf ball with a top coat. In some other instances the surface of the golf ball to which the liquid is applied may be the surface of the core 12 of the golf ball or the surface of the intermediate layer 14 of the golf ball as will be described in further detail below.

It is noted that, additionally, or alternatively, coating materials may be delivered by spray guns (either fixed or articulating types). Examples of devices that may be used include heated spray equipment and electrostatic and high volume-low pressure (HVLP) devices. The golf balls are typically placed on work holders, where they rotate and pass through a spray zone in a specified time to obtain full coverage of their exterior surfaces. Suitable equipment for applying coatings using nitrogen-enriched air is described, for example, in U.S. Pat. No. 6,821,315, the disclosure of which is incorporate by reference in its entirety.

Now the that manufacturing process for producing a golf ball according to aspects of the disclosure has been described above generally, particular aspects of the system and method for producing a golf ball according to aspects of the disclosure will be described in more detail below.

According to aspects of the disclosure, the creation of the outer cover 16 of the golf ball 10 may cause a runner system 200 to be formed around the golf ball 10. For example, as described above, the outer cover 16 may be created by placing the core 12 (and, if applicable, the intermediate layers 14) in a mold (e.g., injection mold) wherein the material used to create the cover is injected into the mold in a liquid state through a plurality of injection ports or gates. The liquid cover material is allowed to flow and substantially fill the cavity 101 between the core 12 and the mold 100 and the cover material is then allowed to solidify around the core. It is noted, that some of the cover material (e.g., molten plastic, etc.) which is injected into the mold 100 may remain in the edge gates 102 of the mold 100. Therefore, when the cover material solidifies, the cover material in the edge gates 102 produces a runner system 200. Therefore, the runner system 200 takes the shape of the channels which comprise the edge gates and sub gates 102.

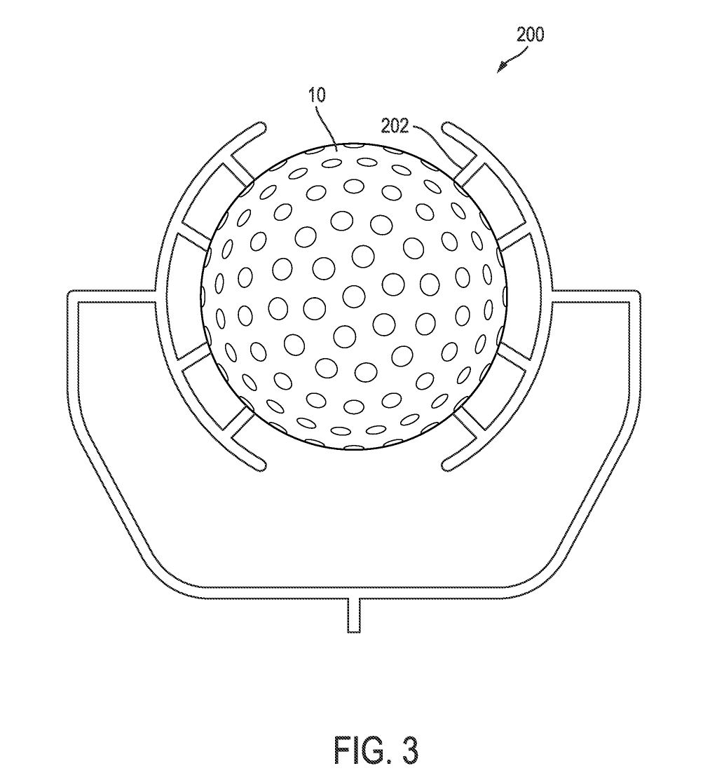

FIG. 3 shows a portion of the runner system 200. As seen in FIG. 3, the illustrated portion of the runner system 200 surrounds a single golf ball 10. Further, as seen by comparing FIG. 3 with FIG. 2B, the illustrated portion of the runner system 200 in FIG. 3 has been separated from the remainder of the runner system 200 which holds the other golf balls that were formed in the mold 100. Further, as seen in FIG. 3, the runner system 200 may include gates 202 at which the runner system 200 is connected to the golf balls. For example, as seen in FIG. 3, one or more gates 202 may attach the runner system 200 to each golf ball 10. As discussed above, the gates 202 may be created from solidified cover material that remains in the channels of the sub gates 102 that feed directly to the cavities 101 of the mold 100 into which of the golf ball core 12 is placed. Therefore, as seen in the depicted embodiment, some of the gates 202 may be linear, while other gates 202 are curved. Further, as seen in the depicted embodiment, the golf balls 10 are each attached to the runner system 200 through eight gates 202 which correspond to the eight channels which surround in the cavity 101 discussed above with regard to mold half 100A. It is noted that the gates 202 and the runner system 200 may be shaped and sized as desired based on the volume of the channels of the sub gates 102. It is noted that, according to aspects of the disclosure, golf balls produced in the mold 100 may be interconnected through a runner system 200. Therefore, according to aspects of the disclosure, through the runner system 200, the golf balls may be removed from the mold halves 100 A and B together in a large matrix.

As also shown in FIG. 3, a golf ball 10 removed from the mold 100 may include flash 203 on the outer surface of the golf ball 10. Flash 203 may be remnants from the material (e.g., solidified plastic, etc.) that was fed into the mold 100 to create the cover of the golf ball. In some embodiments, flash 203 may be thin pieces of plastic that are still attached to the golf ball (e.g., around the diameter of the golf ball) after the forming process is completed and the golf ball 10 is removed from the mold.

It is noted that in conventional methods and systems, the golf balls 10 may be cut or otherwise separated from the runner system 200 when they are removed from the mold 100. For example, conventional systems may automatically separate the mold runner 200 from the golf balls 10 during the ejection of the golf balls 10 from mold halves 100 A and B. It is further noted that in conventional methods and systems for producing golf balls 10, the gates 202 and the flash 203 may also be removed from the golf balls prior to the golf balls being subjected to finishing processes, including buffing (e.g., to remove any remaining gate, or flash, vestige), topcoating, painting, and/or other finishing processes.

However, as will be described in detail below, according to aspects of the disclosure, the runner system 200 or at least portions of the runner system 200 (e.g., some or all of the gates 202) and, also, the flash 203 (or at least part of the flash 203) are not removed from the golf balls prior to the golf balls being subjected to finishing processes, including topcoating, painting, and/or other finishing processes, etc. Instead, according to aspects of the disclosure, the runner system 200 or at least portions of the runner system 200 (e.g., some or all of the gates 202) and, also, the flash 203 (or at least part of the flash 203) may remain attached to the golf balls while the golf balls are subjected to finishing processes, including topcoating, painting, and/or other finishing processes.

Initially, aspects of the disclosure, relating to the flash 203 not being removed from the golf balls prior to the golf balls being subjected to finishing processes, including topcoating, painting, and/or other finishing processes will be described. Thereafter, aspects of the disclosure, relating to the runner system 200 or at least portions of the runner system 200 (e.g., some or all of the gates 202) not being removed from the golf balls prior to the golf balls being subjected to finishing processes, including topcoating, painting, and/or other finishing processes will be described thereafter.

As described above, according to aspects of the disclosure, a finishing process such as applying a coating material (e.g., topcoating) may include applying a liquid (e.g., isocyanate) to the balls. For example, the golf balls 10 may be submerged, or dipped, in the finishing material (e.g., isocyanate) such that the outer cover 16 of the golf ball is exposed to the finishing material and the golf ball 10 is coated evenly in the finishing material.

However, if the flash 203 on the outer cover 16 of the golf ball 10 has been removed (e.g., if the outer cover 16 of the golf ball 10 has been exposed to a finishing process, such as buffing, wherein the flash 203 vestige is removed), then the properties of the outer cover 16 at the areas of the outer cover 16 wherein the flash 203 has been removed may be altered. For example, such areas of the outer cover 16 (wherein the flash 203 has been ground off the golf ball) may have different absorption rates than the remainder of the outer cover 16 of the golf ball 10. Hence, the areas of the outer cover 16 wherein the flash 203 has been removed may absorb a coating material at a different rate of absorption than the remainder of the outer cover 16. This may detract from the dimensional stability of the golf ball 10 and, further, detract from the uniformity of the properties of the golf ball 10. In other words, removing the flash 203 from the outer cover 16 of golf ball 10 prior to applying a coating may reduce the dimensional stability of the golf ball 10 and, further, reduce the uniformity of the properties of the golf ball 10.

In order to further explain the above described scenario, a specific example of a portion of the manufacturing process will be described with respect to an outer cover 16 which includes urethane and a finishing process which includes dipping the golf ball 10 into isocyanate, such that the outer cover 16 of the golf ball is exposed to isocyanate.

In the above described illustrative example, if the outer cover 16 of the golf ball 10 is buffed to remove the flash 203 vestige, such a process may alter the properties of the outer cover 16 of golf ball at those areas wherein the buffing removed the flash 203 vestige. For example, grinding the flash 203 vestige off the golf ball 10 may alter the absorption rate of the urethane in the outer cover 16 of the golf ball at those areas wherein the flash 203 vestige has been removed. Hence, if the flash 203 vestige is ground off of the outer cover 16 of the golf ball prior to dipping the golf ball 10 in the isocyanate, then, when the golf ball is dipped in the isocyanate, the urethane in the areas where the flash 203 vestige is ground off of the outer cover of the golf ball 10 may absorb more isocyanate than the remainder of the outer cover 16 of the golf ball 10. Therefore, the isocyanate may cause the urethane in areas where the flash 203 vestige has been ground off of the outer cover 16 of the golf ball to expand. Therefore, such areas of the outer cover 16 of the golf ball 10 will become enlarged (e.g., “puffed out”) relative to other areas of the outer cover 16 of the golf ball after the dipping. This may negatively affect the dimensional stability of the golf ball 10 and, further, the uniformity of the properties of the golf ball 10. In other words, the dimensional stability of the golf ball 10 and, further, the uniformity of the properties of the golf ball 10 may be reduced.

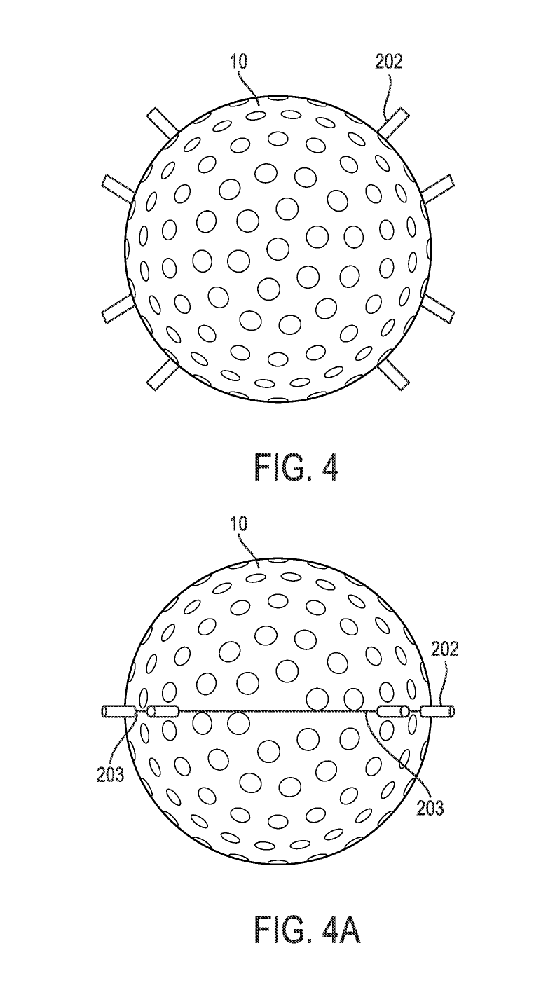

Therefore, according to aspects of the disclosure, the flash 203 may be left on the outer cover 16 of the golf ball until after one or more coating materials have been applied. FIG. 4 illustrates an example embodiment according to aspects of the disclosure wherein the flash 203 (and also the gates 202 as will be described below) remain attached to the golf ball 10 while parts of the runner system 200 have been removed. According to aspects of the disclosure, the embodiment shown in FIG. 4 may be subjected to finishing processes, including topcoating, painting, and/or other finishing processes, etc. It is noted, that while eight gates are shown as attached to the golf ball 10 in FIG. 4, according to other embodiments of the disclosure, some or all the gates 202 may be removed if desired prior to the golf ball 10 being subjected to finishing processes, including topcoating, painting, and/or other finishing processes, etc.

In this way, by leaving the flash 203 attached to the outer cover 16 of the golf ball 10, until after one or more coating materials have been applied, the dimensions of the golf ball and the uniformity of the properties of the golf ball may be better controlled. For example, according to aspects of the disclosure, by not removing the flash 203 attached to the outer cover 16 of the golf ball 10, until after one or more coating materials have been applied, the dimensions of the golf ball and the uniformity of the properties of the golf ball may be increased.

It is noted that according to aspects of the disclosure, if desired, the flash 203 may be removed after one or more coating materials (e.g., a topcoating) has been applied to the golf ball 10. For example, if desired, the flash 203 may be removed by cutting, severing, buffing, ultra-sonically cleaning, other finishing processes, etc. after one or more coating materials (e.g., a topcoating) has been applied to the golf ball 10. For example, the flash 203 may be removed prior to packaging the golf balls 10.

It is noted that while a specific example with respect to an outer cover 16 including urethane and a coating including isocyanate are described above, the disclosure is not limited to such a specific process. For example, aspects of the disclosure may be applied to an outer cover and a coating of any material(s). Further, aspects of the disclosure may relate to not removing the flash 203 until after any coating is applied to the golf ball. In fact, aspects of the disclosure may relate to allowing the flash 203 to remain on the golf ball 10 until the golf ball has been subjected to any, or all, dipping or coating processes throughout the manufacture of the golf ball 10. It is noted that according to some aspects of the disclosure, the flash 203 is not removed by the manufacturer and, therefore, may remain on the golf ball 10 until the golf ball is used.

As described above, according to aspects of the disclosure, the runner system 200 or at least portions of the runner system 200 (e.g., the gates 202) are not removed from the golf balls prior to the golf balls being subjected to finishing processes, including topcoating, painting, and/or other finishing processes, etc. Instead, according to aspects of the disclosure, the runner system 200 or at least portions of the runner system 200 (e.g., the gates 202) may remain attached to the golf balls while the golf balls are subjected to finishing processes, including topcoating, painting, and/or other finishing processes.

For example, as seen in FIG. 4, according to aspects of the disclosure, the gates 202 may remain attached to the golf balls while the golf balls are subjected to finishing processes, including topcoating, painting, and/or other finishing processes. In other words, parts of the runner system 200 may be removed prior to the golf balls being subjected to finishing processes, including topcoating, painting, and/or other finishing processes, etc., while the gates 202 remain attached to the golf balls while the golf balls are subjected to finishing processes, including topcoating, painting, and/or other finishing processes.

It is noted that allowing the runner system 200 or at least portions of the runner system 200 (e.g., the gates 202) to remain attached to the golf balls while the golf balls are subjected to finishing processes, including topcoating, painting, and/or other finishing processes provide similar benefits to the above described benefits (e.g., uniformity of the absorption rates, uniformity in the dimensions and properties of the golf ball, etc.). Further, it is noted that allowing the runner system 200 or at least portions of the runner system 200 (e.g., the gates 202) to remain attached to the golf balls while the golf balls are subjected to finishing processes, including topcoating, painting, and/or other finishing processes provides an advantage that the runner system 200 or at least portions of the runner system 200 (e.g., the gates 202) may be used to move the golf balls 10 through some or all of the remainder of the manufacturing process.

Therefore, according to aspects of the disclosure, the runner system 200 or at least portions of the runner system 200 (e.g., the gates 202), or the flash 203, which is left on the golf ball 10 may be used to move the golf balls through some or all of the reminder of the manufacturing process. For example, according to aspects of the disclosure, the golf balls 10 may be held (e.g., by manual manipulation or automated machinery) by the runner system 200 or at least portions of the runner system 200 (e.g., the gates 202) or the flash 203 as they are transported through the manufacturing process. For example, the golf balls 10 may be held by the runner system 200 or at least portions of the runner system 200 (e.g., the gates 202) or the flash 203 as the golf balls 10 are transported to or from different processes (e.g., finishing processes or other manufacturing steps) in the manufacturing process. Further, golf balls 10 may be held by the runner system 200 or at least portions of the runner system 200 (e.g., the gates 202), or the flash 203, as they are subjected to one or more finishing process, including topcoating, painting, and/or other finishing processes. For example, the golf balls 10 may be held by the runner system 200 or at least portions of the runner system 200 (e.g., the gates 202) or the flash 203 as they are subjected to a dipping process.

According to aspects of the disclosure, the runner system 200 or at least portions of the runner system 200 (e.g., the gates 202), or the flash 203, may be held by clamps, hooks, other mechanical fasteners, vacuum or suction devices (e.g., nozzles), etc. in order to transport the golf balls 10 through the various steps of the manufacturing process, such as described above. Further, it is noted that according to aspects of the disclosure, the system for transporting the golf balls through the manufacturing process may include automated machinery for moving the clamps, hooks, other mechanical fasteners, vacuum or suction nozzles, etc. that are used to hold the golf balls while the golf balls are transported through the various steps of the manufacturing process. Such automated machinery may include conveyor systems (e.g., conveyor belts) or other endless loop systems, etc.

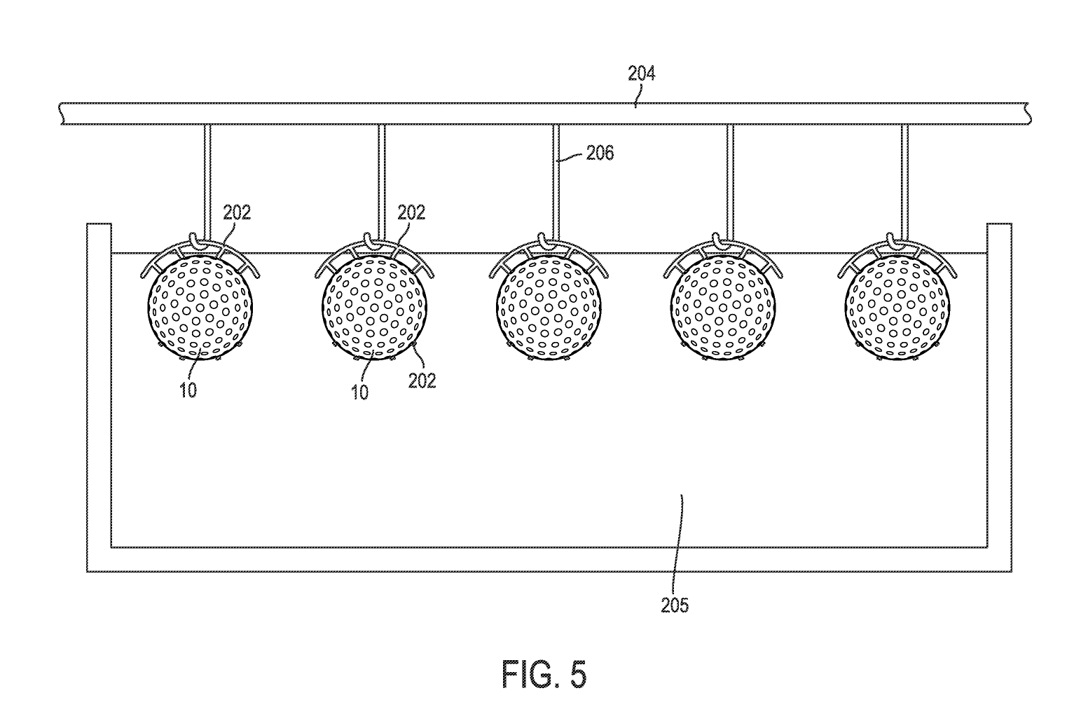

For example, FIG. 5 is a side view of an illustrative embodiment wherein the golf balls 10 are held by a portion of the runner system 200 (e.g., the gates 202 or at least a portion of the gates 202) as the golf balls are subjected to a dipping process. As seen in FIG. 5, a conveyor 204 moves (e.g., dips) golf balls 10 into a container 205 containing a coating material (e.g., isocyanate). Further, as seen in FIG. 5, the runner systems 200 are held by a series of hooks 206 which are moved along by the conveyor 204. The runner system 200 and golf balls 10 within the runner systems 200 are dipped into the container 205 containing a coating material (e.g., isocyanate). For example, the series of hooks 206 may be configured to be raised and lowered to dip the runner systems 200 and golf balls 10 within the runner systems 200 into the container 205 containing a coating material (e.g., isocyanate). As seen in FIG. 5, the hooks 206 may be configured to hold the curved gate 202, but it is noted that as long as the golf balls 10 are securely held, other gates 202 or other portions of the runner system 200 may be used to convey of the golf balls 10 throughout the manufacturing process.

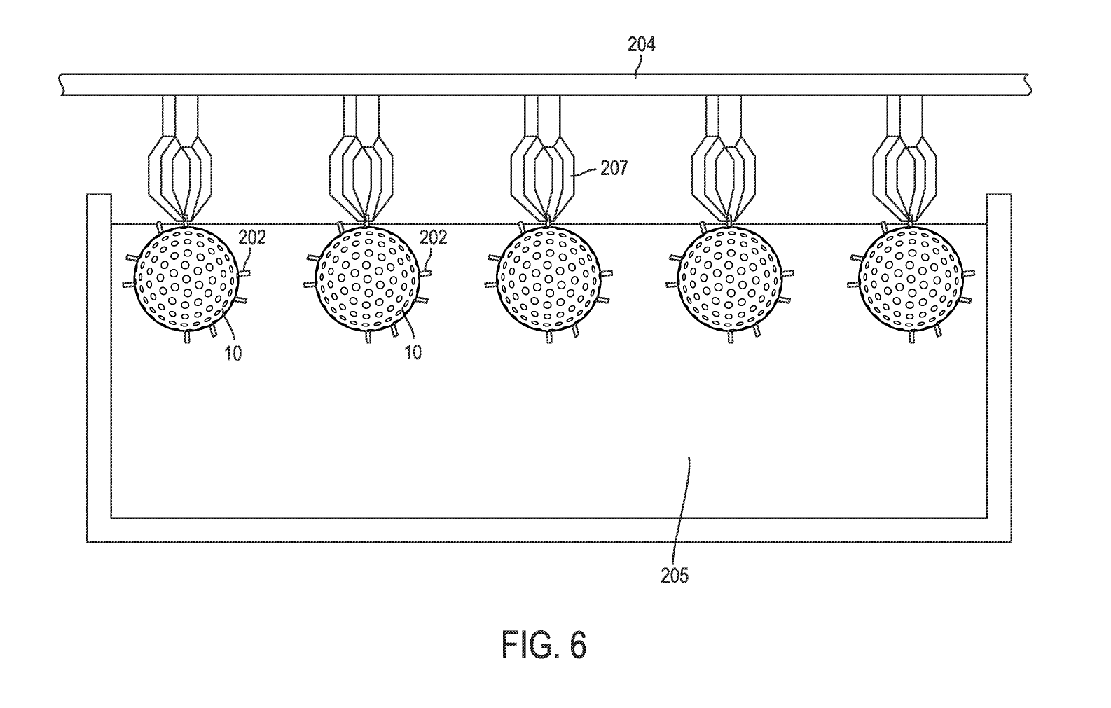

For example, FIG. 6 is a side view of an illustrative embodiment wherein the golf balls 10 are held by a portion of the runner system 200 (e.g., the gates 202 or at least a portion of the gates 202) as the golf balls are subjected to a dipping process. As seen in FIG. 6, a conveyor 204 moves (e.g., dips) golf balls 10 into a container 205 containing a coating material (e.g., isocyanate). Further, as seen in FIG. 6, the runner systems 200 are held by a series of clamps 207 which are moved along by the conveyor 204. The runner system 200 and golf balls 10 within the runner systems 200 are dipped the container 205 containing a coating material (e.g., isocyanate). For example, the series of hooks 206 may be configured to be raised and lowered to dip the runner systems 200 and golf balls 10 within the runner systems 200 into the container 205 containing a coating material (e.g., isocyanate). As seen in FIG. 6, the clamps 207 may be configured to hold one of the linear gates 202, but it is noted that as long as the golf balls 10 are securely held, other gates 202 or other portions of the runner system 200 may be used to convey of the golf balls 10 throughout the manufacturing process.

As discussed above, by leaving the runner system 200 or at least portions of the runner system 200 (e.g., the gates 202) attached to the outer cover of the golf ball 10, until after one or more coating materials have been applied, (similarly to as discussed above with regard to leaving the flash 203 attached to the outer cover 16 of the golf ball 10 until after one or more coating materials have been applied), the dimensions of the golf ball and the uniformity of the properties of the golf ball may be better controlled. For example, according to aspects of the disclosure, by not removing the runner system 200 or at least portions of the runner system 200 (e.g., the gates 202) attached to the outer cover 16 of the golf ball 10, until after one or more coating materials have been applied, the dimensions of the golf ball and the uniformity of the properties of the golf ball may be increased. Therefore, according to aspects of the disclosure, the runner system 200 (or a portion thereof) may be left on the outer cover 16 of the golf ball until after one or more coating materials have been applied.

As described in detail above and shown in FIGS. 5 and 6, according to aspects of the disclosure, parts of the runner system 200 may be removed prior to the golf balls being subjected to finishing processes, including topcoating, painting, and/or other finishing processes, etc., while the gates 202 and/or flash, 203 remain attached to the golf balls while the golf balls are subjected to finishing processes, including topcoating, painting, and/or other finishing processes. However, as will be described in detail below, according to aspects of the disclosure, the entire (or the majority of) runner system 200 itself, is not removed from the golf balls prior to the golf balls being subjected to finishing processes, including topcoating, painting, and/or other finishing processes, etc. Instead, according to aspects of the disclosure, the entire (or the majority of) runner system 200 may remain attached to the golf balls while the golf balls are subjected to finishing processes, including topcoating, painting, and/or other finishing processes.

It is noted that according to aspects of the disclosure, if desired, the entire (or the majority of) runner system 200 may be removed after one or more coating materials (e.g., a topcoating) has been applied to the golf ball 10. For example, if desired, the entire (or the majority of) runner system 200 may be removed by cutting, severing, buffing, ultra-sonically cleaning, other finishing processes, etc. after one or more coating materials (e.g., a topcoating) has been applied to the golf ball 10. For example, runner system 200 may be removed prior to packaging the golf balls 10.

It is noted that further aspects of the disclosure may relate to not removing the entire (or the majority of) runner system 200 until after any subsequent coating is applied to the golf ball. In fact, aspects of the disclosure may relate to allowing the entire (or the majority of) runner system 200 to remain on the golf ball 10 until the golf ball has been subjected to any, or all, dipping or coating processes throughout the manufacture of the golf ball 10.

According to aspects of the disclosure, entire (or the majority of) runner system 200 which is left on the golf ball 10 may be used to move the golf balls through some or all of the reminder of the manufacturing process. For example, according to aspects of the disclosure, the golf balls 10 may be held (e.g., by manual manipulation or automated machinery) by the entire (or the majority of) runner system 200 as the golf balls are transported through the manufacturing process. For example, the golf balls 10 may be held by the entire (or the majority of) runner system 200 as the golf balls 10 are transported to or from different processes (e.g., finishing processes or other manufacturing steps) in the manufacturing process. Further, golf balls 10 may be held by the entire (or the majority of) runner system 200 as the golf balls are subjected to one or more finishing process, including topcoating, painting, and/or other finishing processes. For example, the golf balls 10 may be held by the runner system 200 as the golf balls are subjected to a dipping process.

According to aspects of the disclosure, entire (or the majority of) runner system 200 may be held by clamps, hooks, other mechanical fasteners, vacuum or suction, etc. in order to transport the golf balls 10 through the various steps of the manufacturing process, such as described above. Further, it is noted that according to aspects of the disclosure, the system for transporting the golf balls through the manufacturing process may include automated machinery for moving the clamps, hooks, other mechanical fasteners, vacuum or suction nozzles, etc. that used to hold the golf balls while the golf balls are transported through the various steps of the manufacturing process. Such automated machinery may include conveyor systems (e.g., conveyor belts) or other endless loop systems, etc.

It is noted that while the above described embodiments discuss the concept of coating the outer cover 16 of the golf ball 10 (i.e., applying a coating material to the outer cover 16 of the golf ball 10) when the flash and/or at least a portion of the runner system are still attached to the golf ball, aspects of the disclosure relate to coating other portions of the golf ball 10 (i.e., applying a coating material to the other portions of the golf ball 10) when the flash and/or at least a portion of the runner system are still attached to the golf ball. For example, according to aspects of the disclosure, the formation of the core 12 of the golf ball may produce a core 12 which includes flash and/or at least a portion of a runner system. Further, according to aspects of the disclosure, a coating (such as the coatings described above) may be applied to the core 12 when the flash and/or at least a portion of a runner system are still attached to the core 12 of the golf ball.

Similarly, according to aspects of the disclosure, the formation of the intermediate layer 14 of the golf ball may produce an intermediate layer 14 which includes flash and/or at least a portion of a runner system. Further, according to aspects of the disclosure, a coating (such as the coatings described above) may be applied to the intermediate layer 14 when the flash and/or at least a portion of a runner system are still attached to the intermediate layer 14 of the golf ball.

The above described methods, aspects and advantages of coating the outer cover 16 of the golf ball (e.g., absorption rate uniformity, uniformity of the characteristics of the portions of the golf ball, (e.g., the core or intermediate layers which are coated, etc.) may be applicable to such embodiments of coating the other portions of the golf ball (e.g., the core or intermediate layer) while the flash and/or at least a portion of a runner system are still attached to such portions of the golf ball. Therefore, for the sake of brevity, the methods, aspects and advantages will not be reiterated here.

It is noted that while the above described embodiments discuss the concept of transporting the golf ball via the flash 203 or at least a portion of the runner system 200 attached to the outer cover 16 of the golf ball 10 prior to, during or after applying a coating material to the outer cover 16 of the golf ball 10, aspects of the disclosure relate to transporting the core 12 of the golf ball via the flash attached to the core 12 of the golf ball 10 or at least a portion of the runner system attached to the core 12 of the golf ball 10 prior to, during or after applying a coating material to the core 12 of the golf ball 10.

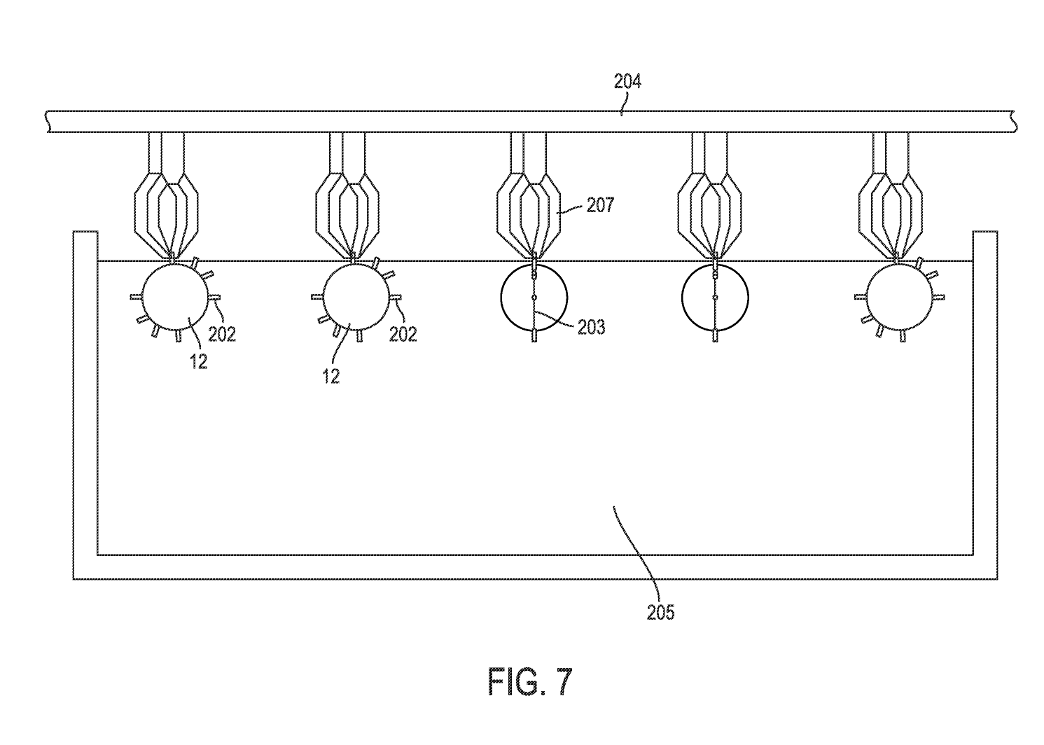

For example, according to aspects of the disclosure, the formation of the core 12 of the golf ball may produce a core 12 which includes flash and/or at least a portion of a runner system. Further, the core 12 of the golf ball may be transported via the flash attached to the core 12 of the golf ball 10 or at least a portion of the runner system attached to the core 12 of the golf ball 10 prior to, during or after applying a coating material to the core 12 of the golf ball 10. FIG. 7 illustrates such an embodiment.

FIG. 7 is a side view of an illustrative embodiment wherein the cores 12 of the golf balls are held by a portion of the runner system 200 (e.g., the gates 202 or at least a portion of the gates 202) as the golf balls are subjected to a dipping process. As seen in FIG. 7, a conveyor 204 moves (e.g., dips) golf balls 10 into a container 205 containing a coating material (e.g., isocyanate or a coating with adhesive). Further, as seen in FIG. 7, the runner systems 200 are held by a series of clamps 207 which are moved along by the conveyor 204. The runner system 200 and cores 12 of the golf balls within the runner systems 200 are dipped the container 205 containing a coating material (e.g., isocyanate or a coating with adhesive). For example, the series of clamps 207 may be configured to be raised and lowered to dip the runner systems 200 and cores 12 of the golf balls within the runner systems 200 into the container 205 containing a coating material (e.g., isocyanate or a coating with adhesive). As seen in FIG. 7, the clamps 207 may be configured to hold one of the linear gates 202, but it is noted that as long as the cores 12 of the golf balls are securely held, other gates 202 or other portions of the runner system 200 may be used to convey of the cores 12 of the golf balls throughout the manufacturing process.

Further, it is noted that while the above described embodiments discuss the concept of transporting the golf ball via the flash 203 or at least a portion of the runner system 200 attached to the outer cover 16 of the golf ball 10 or the core 12 of the golf ball prior to, during or after applying a coating material to the outer cover 16 or core 12 of the golf ball 10, aspects of the disclosure relate to transporting the golf ball (or at least a portion thereof) via the flash or at least a portion of the runner system attached to the intermediate layer 14 of the golf ball 10 prior to, during or after applying a coating material to the intermediate layer 14 of the golf ball 10. For example, according to aspects of the disclosure, the formation of the intermediate layer 14 of the golf ball may produce an intermediate layer which includes flash and/or at least a portion of a runner system. Further, the intermediate layer 14 of the golf ball may be transported via the flash attached to the intermediate layer 14 of the golf ball 10 or at least a portion of the runner system attached to the intermediate layer 14 of the golf ball 10 prior to, during or after applying a coating material to the intermediate layer 14 of the golf ball 10. While the invention has been described in detail in terms of specific examples including presently preferred modes of carrying out the invention, those skilled in the art will appreciate that there are numerous variations and permutations of the above described systems and methods. Thus, the spirit and scope of the invention should be construed broadly as set forth in the appended claims.

We claim:

1. A method of producing a golf ball, comprising:
creating a core of the golf ball;
creating an outer cover of the golf ball around the core of the golf ball; and
applying a liquid to the golf ball,
wherein creating the outer cover of the golf ball around the core of the golf ball, includes creating flash which is attached to the outer cover of the golf ball, wherein at least a portion of the flash, remains attached to the outer cover of the golf ball while the liquid is applied to the golf ball.

2. The method of claim 1, wherein the liquid is a coating material.

3. The method of claim 1, further comprising: removing the at least a portion of the flash after the coating material has been applied.

4. The method of claim 2, wherein the finishing material includes isocyanate.

5. The method of claim 2, wherein the coating material is applied by dipping the golf ball and the at least a portion of the flash in the coating material.

6. The method of claim 1, wherein creating the outer cover of the golf ball around the core of the golf ball, includes creating on or more gates,
wherein the ball is transported through at least a portion of a manufacturing process for producing a golf ball, by holding or manipulating the one or more gates with a conveyor.

7. The method of claim 6, wherein the conveyor is an endless belt conveyor or other endless conveyor.

8. The method of claim 1, wherein hooks, clamps, pins or other mechanical fasteners are applied to the one or more gates to transport the golf ball throughout at least a manufacturing process for producing a golf ball.

9. A golf ball created according to the method of claim 1.

10. A method of producing a golf ball, comprising:
creating a core of the golf ball;
creating an outer cover of the golf ball around the core of the golf ball; and
applying a coating material to the golf ball,
wherein creating the outer cover of the golf ball around the core of the golf ball, includes creating a runner system attached to the outer cover of the golf ball, wherein at least a portion of the runner system remains attached to the outer cover of the golf ball while the coating material is applied to the golf ball.

11. The method of claim 10, further comprising: removing the at least a portion of the runner system after the coating material has been applied.

12. The method of claim 11, wherein the coating material includes isocyanate.

13. The method of claim 12, wherein the outer cover includes urethane.

14. The method of claim 10, wherein the coating material is applied by dipping the golf ball and at least the portion of the runner system in the coating material.

15. The method of claim 10, wherein the ball is transported through at least a portion of a manufacturing process for producing the golf ball, by holding or manipulating at least the portion of the runner system with a conveyor.

16. The method of claim 15, wherein the conveyor is an endless belt conveyor or other endless conveyor.

17. The method of claim 10, wherein hooks, clamps, pins or other mechanical fasteners are applied to at least the portion of the runner system to transport the golf ball throughout at least a manufacturing process for producing a golf ball.

18. A golf ball created according to the method of claim 10.

19. A system for producing a golf ball comprising:
an apparatus for creating a core of the golf ball;
an apparatus for creating an outer cover of the golf ball around the core of the golf ball, wherein the apparatus for creating the outer cover of the golf ball also produces flash on the outer cover of the golf ball and, also, a runner system including one or more gates;
an apparatus for applying a coating material to the outer cover of the golf ball, and
an apparatus for transporting the golf ball through at least a portion of the system by holding or manipulating at least a portion of the runner system.

20. The system of claim 19, wherein the apparatus for transporting the golf ball through at least a portion of the system by holding or manipulating at least the portion of the runner system, transports the golf ball from the apparatus for creating the outer cover of the golf ball around the core of the golf ball, to the apparatus for applying a coating material to the outer cover of the golf ball.

21. The system of claim 19, wherein the apparatus for transporting the golf ball through at least a portion of the system by holding or manipulating at least the portion of the runner system, transports the golf ball from the apparatus for applying a coating material to the outer cover of the golf ball.

22. A method of producing a golf ball, comprising:
creating a core or intermediate layer of the golf ball; and
applying a liquid to the core or intermediate layer of the golf ball,
wherein creating the core or intermediate layer of the golf ball, includes creating flash which is attached to the core or intermediate layer of the golf ball, wherein at least a portion of the flash, remains attached to the core or intermediate layer of the golf ball while the liquid is applied to the core or intermediate layer golf ball.
